(19) United States
(12) Patent Application Publication
(10) Pub. No.: US 2002/0058742 A1
(43) Pub. Date: May 16, 2002

(54) Light-transmissive epoxy resin composition and flip-chip type semiconductor device

(76) Inventors: Tsuyoshi Honda, Gunma-ken (JP); Tatsuya Kanamaru, Gunma-ken (JP); Eiichi Asano, Gunma-ken (JP); Toshio Shiobara, Gunma-ken (JP)

Correspondence Address: BIRCH STEWART KOLASCH & BIRCH, PO BOX 747, FALLS CHURCH, VA, 22040-0747, US

(21) Appl. No.: 09/949,921

(22) Filed: Sep. 12, 2001

(30) Foreign Application Priority Data
Sep. 12, 2000 (JP) 2000-276231

(51) Int. Cl. C08K 3/34

(52) U.S. Cl. 524/492; 524/451

(57) ABSTRACT

A light-transmissive epoxy resin composition comprising (A) an epoxy resin, (B) a curing accelerator, and (C) an inorganic filler satisfies formula (1):

[{2(n_{A}²+n_{C}²)−(n_{A}+n_{C})²}/2]^{½}<3.0×10⁻³ (1)

wherein n_{A} is the refractive index at 25° C. of the cured product of the unfilled composition, and n_{C} is the refractive index at 25° C. of the inorganic filler. The cured composition has improved heat resistance, humidity resistance and low stress as well as high transparency. The composition is suited for use as an underfill for flip-chip type semiconductor devices for optical communications.

This invention relates to epoxy resin compositions of inorganic filler loading type affording cured products having high transparency, and flip-chip type semiconductor devices sealed with the compositions in a cured state.

### BACKGROUND OF THE INVENTION

While the recent advance of the information technology requires effective transmission and processing of a vast quantity of information bits, what is now under investigation as a substitute for conventional signal transmission through electrical wiring is semiconductor devices which take advantage of the high speed, low loss, non-induction and other desirable features of optical signals and mounting technology used therefor. In particular, interest has increased in applications where ultra-high speed, ultra-high density and ultra-low loss are required as in flip-chip type central processing units (CPU).

Most of prior art opto-functional devices are sealed with epoxy resins which are free of inorganic filler in order that the resin layer be transparent. Such unfilled epoxy resins are not satisfactory when the heat resistance, humidity resistance and low stress property of cured parts are taken into account. On the other hand, conventional epoxy resin compositions for semiconductor encapsulation are loaded with finely divided silica as the inorganic filler. Cured products of such filled compositions have good heat resistance, moisture resistance and low stress property, but are opaque because of the difference in refractive index between the cured epoxy resin and the inorganic filler. There is a need for an epoxy resin sealant which is transparent despite filler loading.

### SUMMARY OF THE INVENTION

An object of the invention is to provide a light-transmissive epoxy resin composition of inorganic filler loading type which exhibits high transparency in the cured state. Another object is to provide a flip-chip type semiconductor device sealed with the epoxy resin composition in the cured state.

It has been found that when an epoxy resin composition comprising an epoxy resin, a curing accelerator, and an inorganic filler as essential components satisfies the relationship of the following formula (1), cured products thereof become highly transparent despite the presence of inorganic filler.

Accordingly, the invention provides a light-transmissive epoxy resin composition comprising (A) an epoxy resin, (B) a curing accelerator, and (C) an inorganic filler, wherein the composition satisfies the relationship of the following formula (1):

[{2(n_{A}²+n_{C}²)−(n_{A}+n_{C})²}/2]^{½}<3.0×10⁻³ (1)

wherein n_{A} is the refractive index at 25° C. of the cured product of the composition excluding the inorganic filler, and n_{C} is the refractive index at 25° C. of the inorganic filler.

Also provided is a flip-chip type semiconductor device sealed with the epoxy resin composition in a cured state.

### BRIEF DESCRIPTION OF THE DRAWINGS

FIG. 1 schematically illustrates the measurement of refractive index and transmittance of a sample.

FIG. 2 is a schematic cross-sectional view of a semiconductor device to which the invention is applied.

### DESCRIPTION OF THE PREFERRED EMBODIMENTS

The light-transmissive epoxy resin composition of the invention includes (A) an epoxy resin, (B) a curing accelerator, and (C) an inorganic filler as essential components and optionally, a curing agent and other components. The type and amount of these components are selected such that the composition may satisfy the relationship of the formula (1).

[{2(n_{A}²+n_{C}²)−(n_{A}+n_{C})²}/2]^{½}<3.0×10⁻³ (1)

In formula (1), n_{A} is the refractive index at 25° C. of the cured product of the composition excluding the inorganic filler, and n_{C} is the refractive index at 25° C. of the inorganic filler. This formula means that the standard deviation of the refractive index of the cured product of the epoxy resin composition excluding the inorganic filler on the basis of the refractive index of the inorganic filler is less than 3.0×10⁻³. For the sake of brevity, the term “filled composition” is used to denote an epoxy resin composition comprising an epoxy resin, a curing accelerator, and an inorganic filler, and “unfilled composition” used to denote an epoxy resin composition comprising an epoxy resin and a curing accelerator, but excluding an inorganic filler.

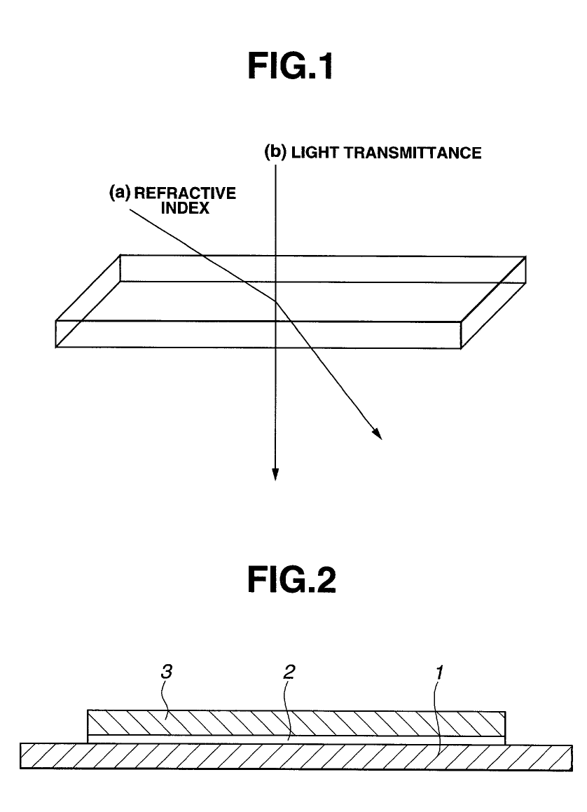

The measurement of a refractive index is now described. The refractive index n_{A} is measured by furnishing the unfilled epoxy resin composition, molding and curing the composition under conventional conditions into a sample as shown in FIG. 1, for example, and measuring the refractive index thereof at 25° C. The refractive index n_{C} of the inorganic filler is measured by dispersing the inorganic filler in a solvent mixture of dimethylsulfoxide (n_{D}=1.4783 at 25° C.) and 1-chloronaphthalene (n_{D}=1.6305 at 25° C.) in a weight ratio of inorganic filler/solvent mixture of 50/50, and determining the refractive index at 25° C. of the solvent mixture at which the dispersion exhibits a light transmittance of at least 99.9% at each wavelength of 1600 nm, 900 nm and 600 nm, that refractive index being regarded as the refractive index of the inorganic filler.

The standard deviation of refractive index given by [{2(n_{A}²+n_{C}²)−(n_{A}+n_{C})²}/2]^{½} is less than 3.0×10⁻³, usually 0 to 2.5×10⁻³, preferably 0 to 2.2×10⁻³, more preferably 0 to 1.5×10⁻³, and most preferably 0 to 0.8×10⁻³. If this value is more than 3.0×10⁻³, the cured product has a reduced light transmittance, compromising the object of the invention.

In the epoxy resin composition of the invention, the epoxy resin (A) is not particularly limited in molecular structure and molecular weight, but selected so that the relationship of formula (1) may stand between the refractive index of the cured product of the unfilled epoxy resin composition and the refractive index of the inorganic filler.

Illustrative examples of suitable epoxy resins include bisphenol-type epoxy resins such as bisphenol A epoxy resin, bisphenol F epoxy resin and bisphenol S epoxy resin, novolac-type epoxy resins such as phenolic novolac epoxy resin and cresol novolac epoxy resin, triphenolalkane-type epoxy resins such as triphenolmethane epoxy resin and triphenolpropane epoxy resin, phenolaralkyl-type epoxy resins, biphenylaralkyl-type epoxy resins, stilbene-type epoxy resins, naphthalene-type epoxy resins, biphenyl-type epoxy resins, cyclopentadiene-type epoxy resins, and alicyclic epoxy resins. These epoxy resins may be used singly or as mixtures of two or more thereof. The epoxy resin is selected in accordance with the refractive index of a particular inorganic filler. Most often, low refractive index resins such as alicyclic epoxy resins are selected for an inorganic filler having a low refractive index whereas high refractive index resins such as naphthalene type epoxy resins are selected for an inorganic filler having a high refractive index.

The curing accelerator (B) used herein is not critical although it is preferably selected depending on whether or not the curing agent is used or the type of curing agent if used. Where the epoxy resin is cured alone (self-polymerization type epoxy resin), relatively strong basic compounds such as imidazole compounds are desirable. Where the epoxy resin is cured with curing agents such as acid anhydrides or phenolic resins (acid anhydride curing type or phenol curing type epoxy resin), even relatively weak basic compounds such as organophosphorus compounds are employable as well as imidazole compounds. Illustrative examples of suitable imidazole compounds include 2-methylimidazole, 2-ethylimidazole, 4-methylimidazole, 4-ethylimidazole, 2-phenylimidazole, 2-phenyl-4-methylimidazole, 2-phenyl-4-hydroxymethylimidazole, 2-ethyl-4-methylimidazole, 1-cyanoethyl-2-methylimidazole, 2-phenyl-4-methyl-5-hydroxymethylimidazole, and 2-phenyl-4,5-dihydroxymethylimidazole. Organophosphorus compounds that may be used herein include triorganophosphines such as triphenylphosphine, tributylphosphine, tri(p-methylphenyl)phosphine, tri(nonylphenyl)phosphine, tri(p-toluyl)phosphine, tri(p-methoxyphenyl)phosphine, tri(p-ethoxyphenyl)phosphine, and triphenylphosphine-triphenylboran; and organophosphines and derivatives thereof, for example, quaternary phosphonium salts such as tetraphenylphosphonium tetraphenylborate. Of these, combinations of acid anhydride curing agents with imidazole compounds or organophosphine compounds are desirable because of the transparency of cured products.

The amount of the curing accelerator added is not critical although an appropriate amount is about 0.1 to 40 parts by weight per 100 parts by weight of the epoxy resin. Particularly when the epoxy resin is cured alone, about 1 to 40 parts by weight of the curing accelerator is used per 100 parts by weight of the epoxy resin. Where curing agents such as acid anhydrides and phenolic resins are used, about 0.1 to 20 parts by weight of the curing accelerator is used per 100 parts by weight of the epoxy resin. An amount of the curing accelerator below the range may invite losses of humidity resistance and heat resistance due to undercure. With an amount of the curing accelerator beyond the range, the composition in uncured state may become unstable during storage.

Component (C) may be any type of inorganic filler. Suitable fillers include crystalline or amorphous silica, talc, mica, silicon nitride, boron nitride and alumina. The only requirement is that the filler be selected so that the relationship of formula (1) may be met by the refractive index of the cured product of the unfilled composition and the refractive index of the inorganic filler. Therefore, a filler whose refractive index is relatively high and can be adjusted as appropriate depending on the type of cured epoxy resin is desirable. In this sense, it is desirable to use an amorphous silica-titania co-melt, also known as silica-titania glass.

The amorphous silica-titania co-melt (i.e., silica-titania glass) may be prepared by a conventional sol-gel process using an alkoxysilane and an alkoxytitanium as starting reactants. Then the refractive index of the inorganic filler can be adjusted in terms of the blending proportion of reactants. An appropriate blending proportion of reactants, that is, alkoxysilane/alkoxytitanium is in the range from 99/1 to 50/50, especially from 90/10 to 70/30 in molar ratio. If the blending proportion of reactants is outside the range, the refractive index of the inorganic filler may largely differ from that of the cured product of the unfilled composition, resulting in the cured product of the filled composition becoming opaque.

The shape and particle size of amorphous silica-titania co-melt are not critical and may be selected in accordance with a particular application. For use as an underfill for flip-chip type semiconductor devices, the preferred co-melt has an irregular shape with no acute corners or spherical shape as well as an average particle size at most about one-tenth as large and a maximum particle size at most one-half as large as the gap between the substrate and chip in a flip-chip semiconductor device. Specifically, the average particle size is usually up to 10 μm, preferably 0.5 to 10 μm, more preferably 1 to 5 μm and the maximum particle size is up to 50 μm, preferably up to 25 μm, and more preferably up to 12 μm. The average particle size may be suitably determined as the weight average value or median diameter, for example, by laser diffraction analysis.

The amount of amorphous silica-titania co-melt added is not critical although it is desirable from the requirement of formula (1) for the co-melt to account for 10% to 100% by weight, more preferably 30% to 100% by weight, and most preferably 50% to 100% by weight of all inorganic fillers. If the amount of amorphous silica-titania co-melt added is below the range, cured products may become opaque. The addition amount of all inorganic fillers including the amorphous silica-titania co-melt is preferably about 50 to 1,000 parts, especially about 100 to 500 parts by weight per 100 parts by weight of the total of other components. If the amount of inorganic filler added is below the range, cured products may lose, in part, heat resistance, humidity resistance and low stress property. An excessive amount of inorganic filler may provide an uncured composition with an extremely increased viscosity, compromising the working efficiency.

In the epoxy resin composition of the invention, a curing agent may be added as component (D). Illustrative of the curing agent are acid anhydrides, phenolic resins, and amine compounds, with the acid anhydrides being desirable for the transparency of cured products. The type of the acid anhydride is not critical although preferred acid anhydrides include aliphatic acid anhydrides such as dodecenylsuccinic anhydride, polyadipic anhydride, polyazelaic anhydride and polysebacic anhydride; alicyclic acid anhydrides such as methyltetrahydrophthalic anhydride, methylhexahydrophthalic anhydride, hymic anhydride, hexahydrophthalic anhydride, tetrahydrophthalic anhydride, trialkyltetrahydrophthalic anhydride and methylcyclohexane dicarboxylic anhydride.

The amount of acid anhydride blended is not critical although an appropriate amount is to give an epoxy resin/acid anhydride ratio between 100/50 and 100/200, and especially between 100/80 and 100/125 in equivalent ratio. An amount of the acid anhydride outside the range can sometimes cause undercure, resulting in losses of humidity resistance and heat resistance.

In the epoxy resin composition, other additives such as flame retardants, coupling agents and thermoplastic resins may be blended insofar as they do not compromise the objects of the invention.

When the epoxy resin composition of the invention is prepared, the respective components may be blended in any desired order and mixed in any desired way. For example, a pre-blend of the components is mixed in a two-roll mill, three-roll mill, kneader or mixer of any desired type while heating if desired.

The epoxy resin composition is obtained in a solid or liquid state. In the solid state, it is used in the form of granules, tablets or film. In the liquid state, it is used as being filled in a suitable container such as a syringe. The epoxy resin composition is usually cured by heating at a temperature of about 100 to 150° C. for about 1 to 6 hours.

The epoxy resin composition cures into a product having high transparency and improved properties such as heat resistance, humidity resistance and low stress due to the inclusion of inorganic filler. These features make the composition especially suitable as an underfill material for flip-chip type semiconductor devices for optical communications.

### EXAMPLE

Examples of the invention and comparative examples are given below by way of illustration, and are not intended to limit the invention.

### Example 1-4 and Comparative Examples 1-2

Epoxy resin compositions were prepared by blending epoxy resins A to C, a curing accelerator (2E4MZ: 2-ethyl-4-methylimidazole), inorganic fillers A to E (amorphous silica-titania co-melt obtained by a sol-gel process) shown in Table 1, and a curing agent (4MTHPA: 4-methyltetrahydrophthalic anhydride) according to the formulation shown in Table 2, followed by intimate mixing.

Each epoxy resin composition was cured under conditions: 100° C./1 hour plus 150° C./4 hours into a test sample of 10 mm×50 mm×0.1 mm (optical path length) as shown in FIG. 1.

Separately, a semiconductor device as shown in FIG. 2 was prepared by coating each epoxy resin composition on a BT substrate 1 as a coating 2 of 10 mm×10 mm×0.1 mm, on which a silicon chip 3 of 10 mm×10 mm×0.3 mm was placed. The composition was cured under conditions: 100° C./1 hour plus 150° C./4 hours, completing the device.

These epoxy resin compositions were examined by the following tests (a) to (d). The results are shown in Table 2.

(a) Refractive Index

For the cured products of unfilled epoxy resin compositions, test samples as shown in FIG. 1 were prepared under the same conditions as used for the cured products of the filled epoxy resin compositions. These samples were measured for refractive index n_{A}. The refractive index n_{c} of an inorganic filler was measured by dispersing the inorganic filler in a solvent mixture of dimethylsulfoxide (n_{D}=1.4783 at 25° C.) and 1-chloronaphthalene (n_{D}=1.6305 at 25° C.) in a weight ratio of inorganic filler/solvent mixture of 50/50, and determining the refractive index n_{C} of the solvent mixture when the dispersion exhibited a light transmittance of at least 99.9% at each wavelength of 1600 nm, 900 nm and 600 nm. All measurements were made at 25° C. It is noted that the mixing ratio of solvents in the solvent mixture was not fixed. Instead, a number of solvent mixtures having different mixing ratios were furnished, the inorganic filler was dispersed therein, the dispersed systems were observed for transparency, and the refractive index of the solvent mixture from which a transparent system was obtained was regarded as the refractive index of the inorganic filler.

(b) Light Transmittance

The test sample of FIG. 1 was measured for light transmittance at a wavelength of 1600 nm, 900 nm and 600 nm and 25° C.

(c) Solder Crack Resistance After Moisture Absorption

A semiconductor device as shown in FIG. 2 was allowed to stand for 24 hours in an atmosphere of 121° C., RH 100% and 2 atm. It was immersed for 10 seconds in a solder bath at 240° C. The number of cracked samples per the total number of tested samples is reported.

(d) Thermal Cycling Test

A semiconductor device as shown in FIG. 2 was immersed for 10 seconds in a solder bath at 240° C. and then for 10 seconds in liquid nitrogen. The number of cracked samples after ten cycles per the total number of tested samples is reported.

TABLE 1
Epoxy resin A: epoxy equivalent 141

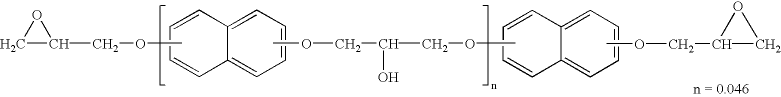

Epoxy resin B: epoxy equivalent 172

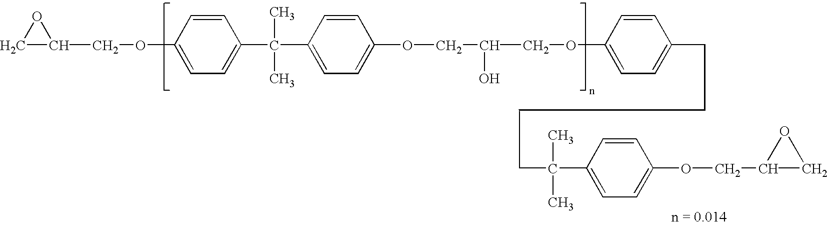

Epoxy resin C: epoxy equivalent 126

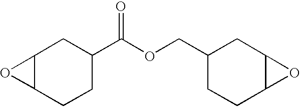

| | | Blending ratio | | Average | Maximum |
|---|---|---|---|---|---|
| | | (mol %) | | particle size | particle size |
| | | SiO₂ | TiO₂ | (μm) | (μm) |
| Inorganic | A | 85 | 15 | 4.5 | ≦12 |
| filler | B | 86 | 14 | 3.8 | ≦12 |
| | C | 87 | 13 | 4.8 | ≦12 |
| | D | 88 | 12 | 4.2 | ≦12 |
| | E | 89 | 11 | 5.2 | ≦12 |

TABLE 2

| | | | | | Comparative | |
|---|---|---|---|---|---|---|
| Composition | Example | | | | Example | |
| (pbw) | 1 | 2 | 3 | 4 | 1 | 2 |
| Epoxy resin A | 62.6 | 40.1 | 18.9 | 0 | 0 | 0 |
| Epoxy resin B | 0 | 24.1 | 46.8 | 53.8 | 67.2 | 67.2 |
| Epoxy resin C | 0 | 0 | 0 | 9.8 | 0 | 0 |
| 2E4MZ | 1 | 1 | 1 | 1 | 1 | 1 |
| Inorganic | 100 | 0 | 0 | 0 | 0 | 0 |
| filler A | | | | | | |
| Inorganic | 0 | 100 | 0 | 0 | 0 | 0 |
| filler B | | | | | | |
| Inorganic | 0 | 0 | 100 | 0 | 0 | 0 |
| filler C | | | | | | |
| Inorganic | 0 | 0 | 0 | 100 | 0 | 0 |
| filler D | | | | | | |
| Inorganic | 0 | 0 | 0 | 0 | 100 | 0 |
| filler E | | | | | | |
| 4MTHPA | 37.4 | 35.8 | 34.3 | 37.0 | 32.8 | 32.8 |
| (a) Refractive | | | | | | |
| index | | | | | | |
| n_{A} | 1.545 | 1.541 | 1.538 | 1.531 | 1.535 | 1.535 |
| n_{C} | 1.544 | 1.539 | 1.535 | 1.530 | 1.526 | — |
| formula (1) | 0.707 | 1.414 | 2.121 | 0.707 | 6.364 | — |
| (×10⁻³⁾ | | | | | | |
| (b) Trans- | | | | | | |
| mittance | | | | | | |
| 1600 nm | 100 | 100 | 100 | 100 | 95 | 100 |
| 900 nm | 100 | 100 | 100 | 100 | 80 | 100 |
| 600 nm | 100 | 99 | 99 | 100 | 70 | 100 |
| (c) Solder | 0/20 | 0/20 | 0/20 | 0/20 | 0/20 | 20/20 |
| crack | | | | | | |
| resistance | | | | | | |
| (d) Thermal | 0/20 | 0/20 | 0/20 | 0/20 | 0/20 | 20/20 |
| cycling test | | | | | | |

Note: formula (1): [{2(n_{A}² + n_{C}²) − (n_{A} + n_{C})²}/2]^{½}

There has been described an epoxy resin composition which in the cured state has improved heat resistance, humidity resistance and low stress as well as high transparency. The use of the composition as underfill material for flip-chip type semiconductor devices for optical communications can meet the recently increasing requirements of high speed, low loss and high density.

Japanese Patent Application No. 2000-276231 is incorporated herein by reference.

Although some preferred embodiments have been described, many modifications and variations may be made thereto in light of the above teachings. It is therefore to be understood that the invention may be practiced otherwise than as specifically described without departing from the scope of the appended claims.

1. A light-transmissive epoxy resin composition comprising (A) an epoxy resin, (B) a curing accelerator, and (C) an inorganic filler, wherein
said composition satisfies the relationship of the following formula (1):
[{2(n_{A}²+n_{C}²)−(n_{A}+n_{C})²}/2]^{½}<3.0×10⁻³ (1)
wherein n_{A} is the refractive index at 25° C. of the cured product of the composition excluding the inorganic filler, and n_{C} is the refractive index at 25° C. of the inorganic filler.

2. The epoxy resin composition of claim 1 wherein inorganic filler (C) is an amorphous silica-titania co-melt.

3. The epoxy resin composition of claim 1 further comprising (D) an acid anhydride curing agent.

4. The epoxy resin composition of claim 1 which is used as an underfill for flip-chip type semiconductor devices.

5. A flip-chip type semiconductor device sealed with the epoxy resin composition of claim 1 in a cured state.
